(19) United States
(12) Patent Application Publication
(10) Pub. No.: US 2024/0329726 A1
(43) Pub. Date: Oct. 3, 2024

(54) PROTOCOL FOR BIDIRECTIONAL COMMUNICATION WITHOUT ACTIVE TRANSMISSION

(71) Applicant: INTERNATIONAL BUSINESS MACHINES CORPORATION, Armonk, NY (US)

(72) Inventors: Dinesh C. VERMA, New Castle, NY (US); MUDHAKAR SRIVATSA, White Plains, NY (US); Gerald COON, Durham, NC (US); Utpal MANGLA, Toronto (CA); SATISHKUMAR SADAGOPAN, Leawood, KS (US); Mathews Thomas, Flower Mound, TX (US)

(21) Appl. No.: 18/192,441

(22) Filed: Mar. 29, 2023

(51) Int. Cl. G06F 3/00; G06F 3/14; G06V 30/224

(52) U.S. Cl. CPC G06F 3/005; G06F 3/14; G06V 30/224

(57) ABSTRACT

A first computational device with a first visual display and a second computational device with a second visual display are maintained, wherein the first computational device is configured to read information displayed on the second visual display, and wherein the second computational device is configured to read information displayed on the first visual display. Byte streams are exchanged bidirectionally between the first computational device and the second computational device via the information displayed on the first visual display and the information displayed on the second visual display, wherein active radio transmission between the first computational device and the second computational device is avoided.

### BACKGROUND

Embodiments relate to a method, system, and computer program product for a protocol for bidirectional communication without active transmission.

Traditional data communication mechanisms that are based on electrically wired, wireless, acoustic, or fibre optic-based schemes are often used in computing environments. In such mechanisms, data may be transmitted either over a wired or wireless network. Optical communication is communication at a distance using light to carry information. Optical communication may be performed visually or by using electronic devices.

An optical communication system uses a transmitter, where the transmitter encodes a message into an optical signal. A channel carries the optical signal to its destination. A “receiver” reproduces the message from the received optical signal. When electronic equipment is not employed the “receiver” is an entity that visually observes and interprets a signal, which may be either simple (e.g., a beacon fire) or complex (e.g., lights flashed in a Morse code sequence). Visual techniques such as smoke signals, beacon fires, hydraulic telegraphs, ship flags and semaphore lines comprised some of the early forms of optical communication, prior to the advent of modern electronic transmission.

### SUMMARY

Provided are a method, system, and computer program product in which a first computational device with a first visual display and a second computational device with a second visual display are maintained, wherein the first computational device is configured to read information displayed on the second visual display, and wherein the second computational device is configured to read information displayed on the first visual display. Byte streams are exchanged bidirectionally between the first computational device and the second computational device via the information displayed on the first visual display and the information displayed on the second visual display, wherein active radio transmission between the first computational device and the second computational device is avoided.

In additional embodiments, a header comprising one or more bytes is used to synchronize sequences of information exchanged between the first computational device and the second computational device.

In further embodiments, the first computational device is a sender, wherein the second computational device is a receiver, and wherein the sender advances a next set of information in a byte stream, in response to the receiver acknowledging a prior set of information.

In yet further embodiments, the sender and the receiver are configured to reverse roles for bidirectional message transfer.

In certain embodiments, the information on the first visual display and the information of the second visual display are displayed as a Quick Response (QR) code or any other type of visual code.

In further embodiments, a shared dictionary is maintained between the first computational device and the second computational device to map a number displayed via the QR code or any other type of visual code on the first visual display or the second visual display to a random encryption key for ensuring encrypted communication between the first computational device and the second computational device.

In additional embodiments, operations for exchanging information implement a Transmission Control Protocol (TCP), a User Datagram Protocol (UDP) or Real-Time Transport Protocol (RTP) or any other communication protocol included in a network communication scheme.

### BRIEF DESCRIPTION OF THE DRAWINGS

Referring now to the drawings in which like reference numbers represent corresponding parts throughout:

FIG. 1 illustrates a block diagram of a computing environment for bidirectional communication without active transmission, in accordance with certain embodiments.

FIG. 2 illustrates a block diagram of an exemplary visual display mechanism for bidirectional communication, in accordance with certain embodiments.

FIG. 3 illustrates a block diagram of a header for bidirectional communication, in accordance with certain additional embodiments.

FIG. 4 illustrates a flowchart that shows operations performed in the computing environment for communication, in accordance with certain additional embodiments.

FIG. 5 illustrates a flowchart that shows additional operations performed in the computing environment for communication, in accordance with certain additional embodiments.

FIG. 6 illustrates a flowchart that shows operations for bidirectional passive data communication via visual means, in accordance with certain additional embodiments.

FIG. 7 illustrates a computing environment in which certain components of FIG. 1 may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

In certain data communication environments, the sender and receiver are not able to have an electronic signal exchange with each other. For example, other devices using the same frequency may be disruptive of the electronic signal exchange between the sender and the receiver. Electronic jamming may also be used to disrupt the transmission of radio frequencies.

It would be desirable in such situations to provide a backup mechanism for communication. For example, a backup mechanism in environments where the primary communication channel (e.g., a cellular network) has been disrupted may be useful. A backup mechanism for communication may also be useful when a first responder is trying to reach someone in distress but cannot communicate via regular electronic means.

Existing solutions to jamming include the use of information theory to determine the best possible codes to deal with the jammed or interfering frequency. However, when radio silence is required and jamming covers all the frequencies that the device can communicate on, these mechanisms may not work.

Certain embodiments use a separate mechanism which requires no transmission and creates a fully functional bidirectional protocol without any active transmission at all. Certain embodiments provide a passive mechanism that relies on visual readable symbols being presented on the surface of the sender which can be visually read by means of a camera on the receiver. Both parties in the communication change their symbols in a way to communicate information to the other without transmitting anything on the radio spectrum. In one embodiment, the solution uses polarized light for communications. Polarization improves the sharpness of the visual signal from a specific angle (similar to removing glare from sunlight reflecting on a wet road) and also adds a layer of protection (similar to a laptop screen protector that limits the viewing angle to 30 degrees on either side).

An example of two devices using the embodiments would be two smartphones placed facing each other. They displayed visual symbols on one screen is read and interpreted using the camera on the other phone. This leads to a completely passive communication mechanism without any radio transmission from either phone and each relying only on local processing and capabilities. As a result, certain embodiments provide improvements to data communication mechanisms in a computing environment.

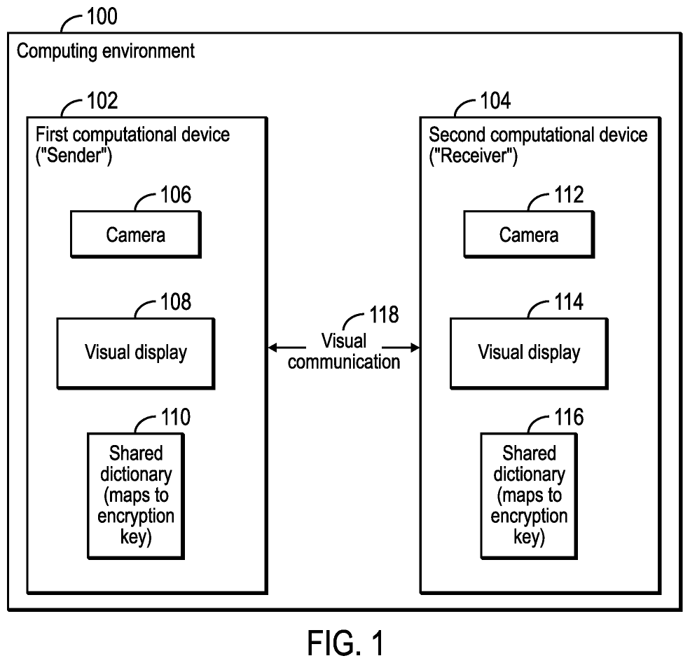

FIG. 1 illustrates a block diagram of a computing environment 100 for bidirectional communication without active transmission, in accordance with certain embodiments.

A first computational device 102 and a second computational device 104 are maintained in the computing environment 100, where the first computational device 102 and the second computational device 104 are unable to perform active transmission of data to each other.

In certain embodiments, the first computational device 102 and the second computational device 104 may comprise any suitable computational device including those presently known in the art, such as, a personal computer, a workstation, a server, a mainframe, a hand held computer, a palm top computer, a head mounted computer, a telephony device, a network appliance, a blade computer, a processing device, a controller, etc.

The first computational device 102 includes a camera 106, a visual display 108, and a shared dictionary 110. The second computational device 104 includes a camera 112, a visual display 114 and a shared dictionary 116. The camera 106 of the first computational device 102 is able to visually take images of items displayed on the visual display 114 of the second computational device 104, and the camera 112 of the second computational device 104 is able to visually take images of items displayed on the visual display 108 of the first computational device.

The first computational device 102 displays header and payload on the visual display 108 and the second computational device 104 displays header and payload on the visual display 114. The first computational device 102 and the second computational device 104 are in visual communication range of each other (as shown via reference numeral 118). The displayed header and payload on the visual display of one computational device is read via the camera of the other computational device and a communication protocol is implemented in certain embodiments for bidirectional data transfer between the first computational device 102 and the second computational device 104.

A shared dictionary 110 is maintained in the first computational device 102 and a corresponding shared dictionary 116 is maintained in the second computational device 104. The shared directories contain mapping to encryption keys used for encrypted data transmission between the computational devices 102, 104.

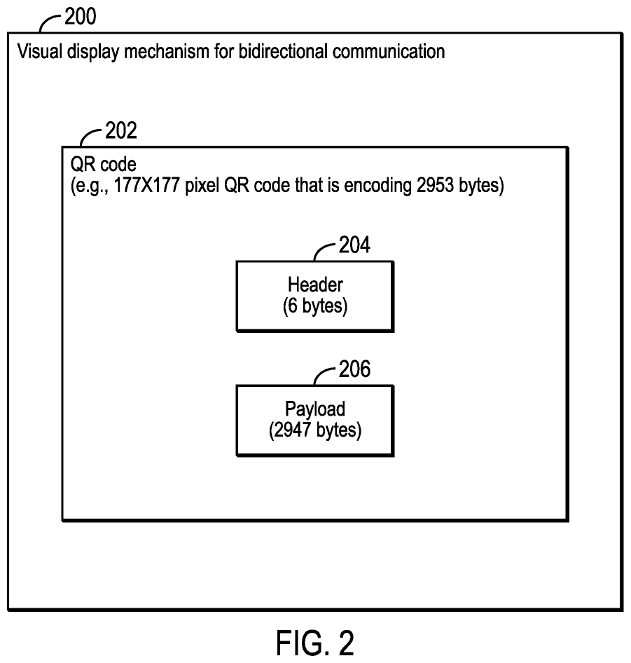

FIG. 2 illustrates a block diagram 200 of an exemplary visual display mechanism for bidirectional communication, in accordance with certain embodiments.

In certain embodiments, a quick response (QR) code is displayed on the visual displays of the computational devices 102, 104 for data transmission via visual means. A QR code is a two-dimensional bar code. Other types of coding mechanism for data besides QR code may be used in alternative embodiments.

In certain embodiments the QR code 202 is a 177 by 177 pixel image that encodes 2953 bytes. In certain exemplary embodiments, a header comprising 6 bytes and a payload comprising 2947 bytes are used. Alternative embodiments may use headers and payloads of different sizes than those shown in FIG. 2.

Certain embodiments implement a protocol for reliable stream communication using a small number of header bytes on a set of packets, where the total size of each packet is limited to 2953 bytes or the QR code capacity as shown in FIG. 2.

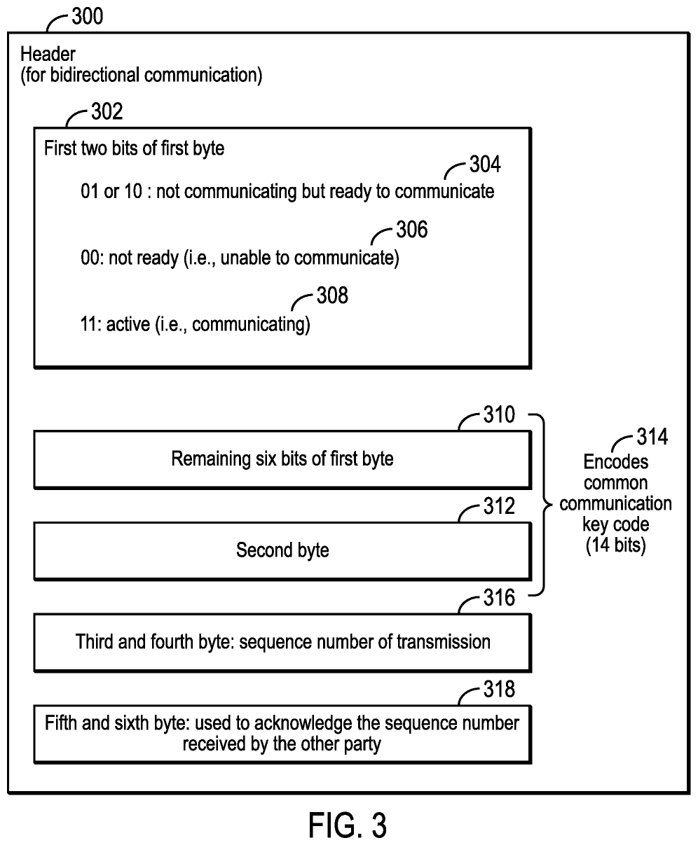

FIG. 3 illustrates a block diagram of a header 300 for bidirectional communication, in accordance with certain additional embodiments.

In certain embodiments, the header 300 is comprised of 6 bytes. Of this header, the first two bits 302 of the first byte of the QR code is used to encode the state of the communication, which is either ready (shown via reference numeral 304 and represented by 01 or 10 which means not communicating but ready to communicate), not ready (shown via reference numeral 306 and represented by 00 which means unable to communicate) or active (shown via reference numeral 308 and represented by 11 which means communicating).

The 6 bits of the first byte and 8 bits of the second byte include a number that encodes a common communicate key code that is shared among the sender and the receiver, where the sender and receiver may be the first computational device 102 and the second computational device 104 respectively (shown via reference numerals 310, 312, 314).

In certain embodiments the third and fourth byte of the header indicates a sequence number of transmission (shown via reference numeral 316). The fifth and the sixth byte of the header may be used to acknowledge the sequence number received by the other party (shown via reference numeral 318).

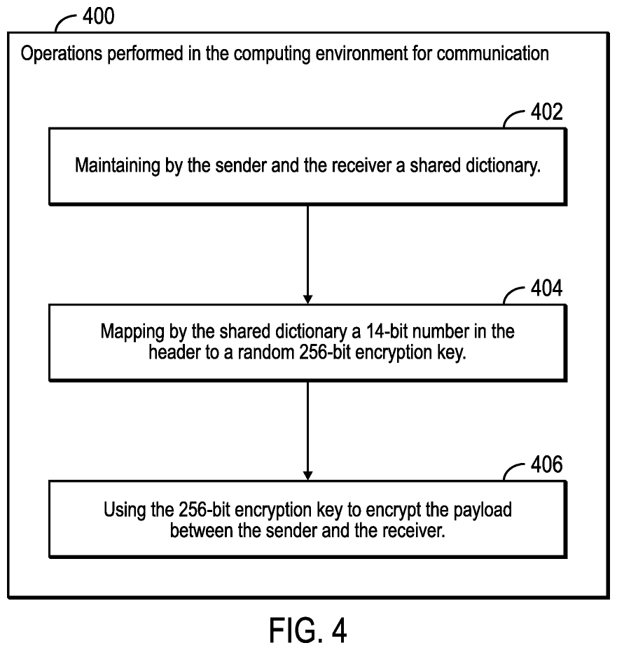

FIG. 4 illustrates a flowchart 400 that shows operations performed in the computing environment 100 for communication, in accordance with certain additional embodiments. The operations shown in flowchart 500 may be implemented in the computational devices 102, 104 of the computing environment 100.

Control starts at block 402 in which the sender 102 (first computational device 102) and the receiver 104 (second computational device) maintains a shared dictionary. Control proceeds to block 404 in which the shared dictionary is used to map a 14-bit number in the header to a random 256 bit encryption key. The 256-bit encryption key is used to encrypt the payload between the sender 102 and the receiver 104 (at block 406).

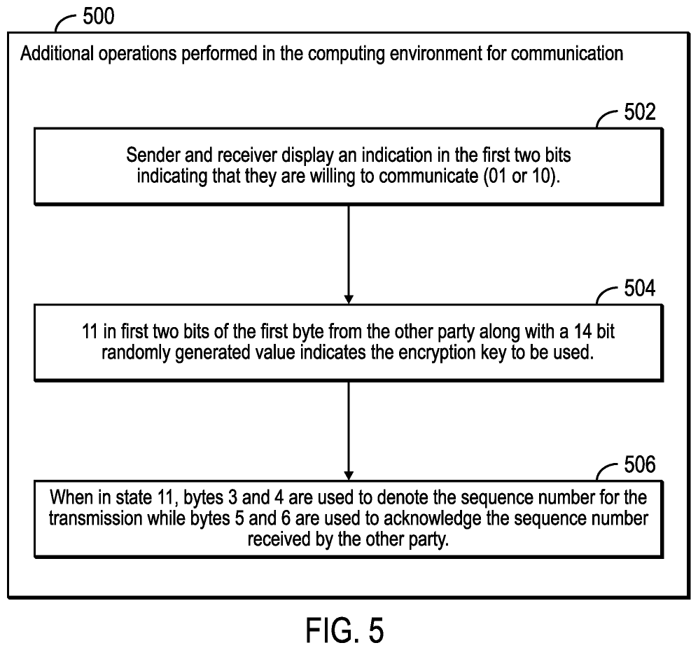

FIG. 5 illustrates a flowchart 500 that shows additional operations performed in the computing environment 100 for communication, in accordance with certain additional embodiments. The operations shown in flowchart 500 may be implemented in the computational devices 102, 104 of the computing environment 100.

The communication begins at block 502 with the sender 102 and receiver 104 displaying an indication in the first two bits indicating that they are willing to communicate (the first two bits are 01 or 10). This is followed (at block 504) by a 11 from the other party along with a 14 bit randomly generated value which indicates the encryption key to be used. When in state 11, bytes 3 and 4 are used (at block 506) to denote the sequence number for the transmission while bytes 5 and 6 are used to acknowledge the sequence number received by the other party.

The rest of the bytes (i.e., 2947 bytes) are used to send the payload for the communication. Each side may use a common bit-stuffing marker to indicate the end of the message if all the bytes are not used up in the transmission.

No flow control or congestion control is needed since the communication is a single hop communication. Once a sequence is acknowledged by the receiver, the sender can move to the next set of bytes to be sent. This mechanism is sufficient to implement a fully functional Transmission Control Protocol (TCP) communication between the sender and the receiver, allowing them to communicate in a general manner without any radio transmission.

In additional embodiments, operations for exchanging information may implement a User Datagram Protocol (UDP) or Real-Time Transport Protocol (RTP) or any other communication protocol included in a network communication scheme.

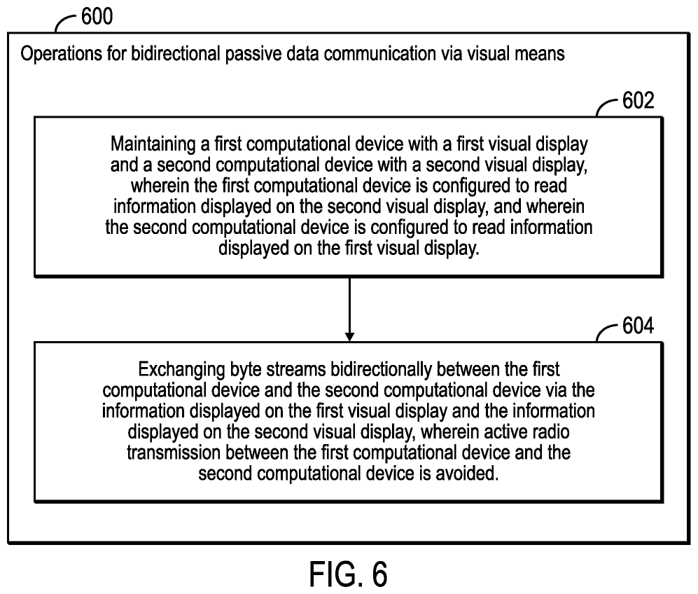

FIG. 6 illustrates a flowchart 600 that shows operations for bidirectional passive data communication via visual means, in accordance with certain additional embodiments. The operations shown in flowchart 600 may be implemented in the computational devices 102, 104 of the computing environment 100.

Control starts at block 602 in which a first computational device 102 with a first visual display 108 and a second computational device 104 with a second visual display 114 are maintained, wherein the first computational device 102 is configured to read information displayed on the second visual display 114, and wherein the second computational device 104 is configured to read information displayed on the first visual display 108.

From block 602 control proceeds to block 604 in which byte streams are exchanged bidirectionally between the first computational device 102 and the second computational device 104 via the information displayed on the first visual display 108 and the information displayed on the second visual display 114, wherein active radio transmission between the first computational device 102 and the second computational device 104 is avoided.

In additional embodiments, a header 300 comprising one or more bytes is used to synchronize sequences of information exchanged between the first computational device 102 and the second computational device 104. In further embodiments, the first computational device 102 is a sender, wherein the second computational device 104 is a receiver, and wherein the sender advances a next set of information in a byte stream, in response to the receiver acknowledging a prior set of information. In yet further embodiments, the sender and the receiver are configured to reverse roles for bidirectional message transfer. In certain embodiments, the information on the first visual display 108 and the information of the second visual display 114 are displayed as a QR code 202 or any other type of visual code.

Therefore, FIGS. 1-6 illustrate certain embodiments for bidirectional data transmission via visual means rather than via active transmission. This improves the performance of computational devices that cannot use active transmission mechanisms.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

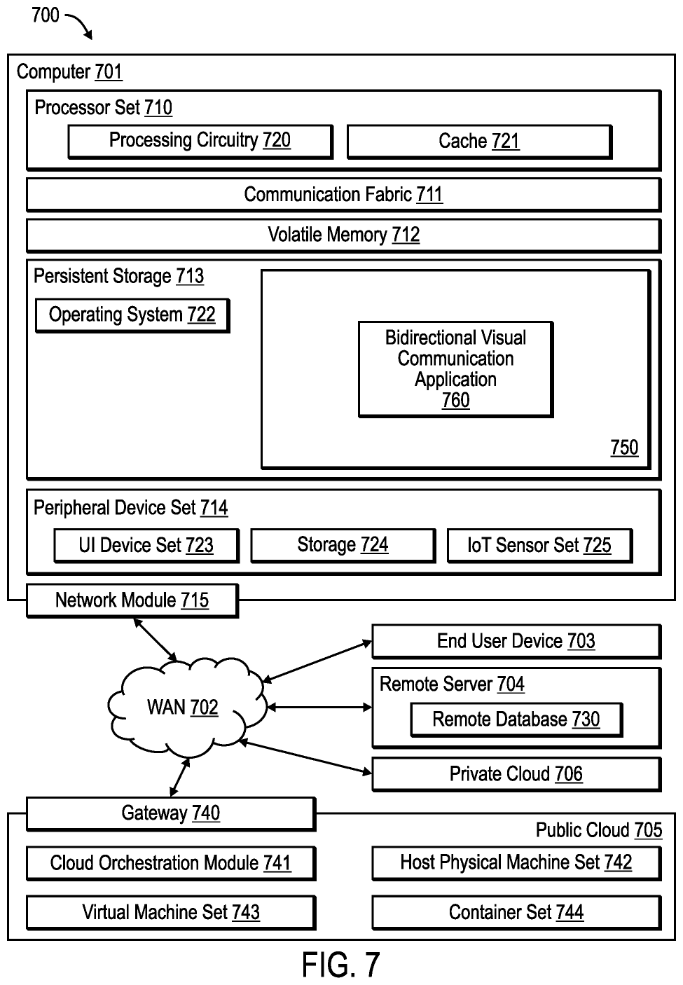

In FIG. 7, computing environment 700 contains an example of an environment for the execution of at least some of the computer code (block 750) involved in performing the operations of a bidirectional visual communication application 760 that performs operations shown in FIGS. 1-6.

In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. I/O T sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
maintaining a first computational device with a first visual display and a second computational device with a second visual display, wherein the first computational device is configured to read information displayed on the second visual display, and wherein the second computational device is configured to read information displayed on the first visual display; and
exchanging byte streams bidirectionally between the first computational device and the second computational device via the information displayed on the first visual display and the information displayed on the second visual display, wherein active radio transmission between the first computational device and the second computational device is avoided.

2. The method of claim 1, wherein a header comprising one or more bytes is used to synchronize sequences of information exchanged between the first computational device and the second computational device.

3. The method of claim 1, wherein the first computational device is a sender and wherein the second computational device is a receiver, and wherein the sender advances a next set of information in a byte stream, in response to the receiver acknowledging a prior set of information.

4. The method of claim 3, wherein the sender and the receiver are configured to reverse roles for bidirectional message transfer.

5. The method of claim 1, wherein the information on the first visual display and the information of the second visual display are displayed as a Quick Response (QR) code or any other type of visual code.

6. The method of claim 5, wherein a shared dictionary is maintained between the first computational device and the second computational device to map a number displayed via the QR code or any other type of visual code on the first visual display or the second visual display to a random encryption key for ensuring encrypted communication between the first computational device and the second computational device.

7. The method of claim 1, wherein operations for exchanging information implement a Transmission Control Protocol (TCP), a User Datagram Protocol (UDP) or Real-Time Transport Protocol (RTP) or any other communication protocol included in a network communication scheme.

8. A system, comprising:
a memory; and
a processor coupled to the memory, wherein the processor performs operations, the operations comprising:
maintaining a first computational device with a first visual display and a second computational device with a second visual display, wherein the first computational device is configured to read information displayed on the second visual display, and wherein the second computational device is configured to read information displayed on the first visual display; and
exchanging byte streams bidirectionally between the first computational device and the second computational device via the information displayed on the first visual display and the information displayed on the second visual display, wherein active radio transmission between the first computational device and the second computational device is avoided.

9. The system of claim 8, wherein a header comprising one or more bytes is used to synchronize sequences of information exchanged between the first computational device and the second computational device.

10. The system of claim 8, wherein the first computational device is a sender and wherein the second computational device is a receiver, and wherein the sender advances a next set of information in a byte stream, in response to the receiver acknowledging a prior set of information.

11. The system of claim 10, wherein the sender and the receiver are configured to reverse roles for bidirectional message transfer.

12. The system of claim 8, wherein the information on the first visual display and the information of the second visual display are displayed as a Quick Response (QR) code or any other type of visual code.

13. The system of claim 12, wherein a shared dictionary is maintained between the first computational device and the second computational device to map a number displayed via the QR code or any other type of visual code on the first visual display or the second visual display to a random encryption key for ensuring encrypted communication between the first computational device and the second computational device.

14. The system of claim 8, wherein operations for exchanging information implement a Transmission Control Protocol (TCP), a User Datagram Protocol (UDP) or Real-Time Transport Protocol (RTP) or any other communication protocol included in a network communication scheme.

15. A computer program product, the computer program product comprising a computer readable storage medium having computer readable program code embodied therewith, the computer readable program code when executed is configured to perform operations, the operations comprising:
maintaining a first computational device with a first visual display and a second computational device with a second visual display, wherein the first computational device is configured to read information displayed on the second visual display, and wherein the second computational device is configured to read information displayed on the first visual display; and
exchanging byte streams bidirectionally between the first computational device and the second computational device via the information displayed on the first visual display and the information displayed on the second visual display, wherein active radio transmission between the first computational device and the second computational device is avoided.

16. The computer program product of claim 15, wherein a header comprising one or more bytes is used to synchronize sequences of information exchanged between the first computational device and the second computational device.

17. The computer program product of claim 15, wherein the first computational device is a sender and wherein the second computational device is a receiver, and wherein the sender advances a next set of information in a byte stream, in response to the receiver acknowledging a prior set of information.

18. The computer program product of claim 17, wherein the sender and the receiver are configured to reverse roles for bidirectional message transfer.

19. The computer program product of claim 15, wherein the information on the first visual display and the information of the second visual display are displayed as a Quick Response (QR) code or any other type of visual code.

20. The computer program product of claim 19, wherein a shared dictionary is maintained between the first computational device and the second computational device to map a number displayed via the QR code or any other type of visual code on the first visual display or the second visual display to a random encryption key for ensuring encrypted communication between the first computational device and the second computational device.
